(19) United States
(12) Patent Application Publication
(10) Pub. No.: US 2026/0336988 A1
(43) Pub. Date: Oct. 29, 2026

(54) Lightweight Compact Winch

(71) Applicants: Ryan Neil, Bend, OR (US); Jake Ruhl, Bend, OR (US)

(72) Inventors: Ryan Neil, Bend, OR (US); Jake Ruhl, Bend, OR (US)

(21) Appl. No.: 19/656,862

(22) Filed: Apr. 23, 2026

Related U.S. Application Data
(60) Provisional application No. 63/793,346, filed on Apr. 23, 2025.

(51) Int. Cl. B66D 1/06

(52) U.S. Cl. CPC B66D 1/06

(57) ABSTRACT

The invention is a lightweight, compact winching system designed to lift and pull heavy loads. It's constructed from aerospace-grade aluminum and features a cylindrical spool coupled with toothed gears for secure load handling. The winch incorporates a dual-pawl release mechanism for controlled load management and a safety system to prevent simultaneous disengagement under load. Complementing the winch is the Capio, a temporary rope termination device equipped with a friction bollard, clamping plate, and spring latch for secure grip and controlled release of high-strength ropes. Together, the winch and Capio provide a lightweight, durable, and reliable solution for efficient load management in remote or confined environments.

### CROSS REFERENCE TO RELATED APPLICATIONS

This application claims priority to the copending U.S. Application, Serial No. 63/793,346, filed on Apr. 23, 2025, which is hereby incorporated by reference in its entirety.

### BACKGROUND

The present disclosure relates generally to load-bearing devices, in the present invention being a winch. The present invention is a lightweight, portable winching system designed for outdoor enthusiasts, rescue operations, and utility workers who need a compact and efficient tool for lifting or pulling heavy loads in remote or confined spaces.

Conventional winches, such as those used for vehicle recovery, wilderness rescues, tree or agricultural work, maritime applications, and construction, are often bulky and heavy, and they often rely on external power sources like vehicle electrical systems or large batteries to operate. These characteristics limit the utility of a conventional winch in situations where it is too burdensome to carry or use during normal daily operations.

In situations where large line loads are necessary to move heavy objects, a light, portable, easily packable winch can favorably enhance outcomes. Thus, there is a need for a portable, compact, lightweight winch that improves upon existing winch designs. Examples of new and useful winches relevant to existing field needs are discussed below.

### SUMMARY

The Light Weight Compact Winch is a portable, efficient device designed for lifting and pulling heavy loads in outdoor, rescue, and utility applications. Constructed from aerospace-grade aluminum, it features a cylindrical spool holding 20 feet of high-strength synthetic rope and toothed gears for secure load handling. The winch incorporates a dual-pawl release mechanism for controlled load management and a safety system to prevent simultaneous disengagement under load. It supports single-line pulls up to 1,000 lbs and double-line pulls up to 2,000 lbs, offering versatility for various scenarios. Complementing the winch is the Capio, a temporary rope termination device equipped with a friction bollard, clamping plate, and spring latch to provide a secure grip and controlled release of high-strength ropes. Together, the winch and Capio provide a lightweight, durable, and reliable solution for efficient load management in remote or confined environments.

### BRIEF DESCRIPTION OF THE DRAWINGS

FIG. 1A is a front view of the upper and lower handles.

FIG. 1B is a side view of the upper and lower handles.

FIG. 1C is a rear view of the upper and lower handles.

FIG. 2 is a transparent view of the winch with the crank pawl engaged.

FIG. 3 is a transparent view of the winch with the frame pawl engaged.

FIG. 4A is a top view of the Capio.

FIG. 4B is a bottom view of the Capio.

FIG. 5A is a left-hand exploded view of the Capio.

FIG. 5B is a center exploded view of the Capio.

FIG. 5C is a right-hand exploded view of the Capio.

### DETAILED DESCRIPTION

The disclosed winch will be better understood by reviewing the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various winches are provided. Related features across examples may be identical, similar, or dissimilar. For the sake of brevity, related features will not be redundantly explained in each example. Instead, using related feature names will cue the reader that a feature with a related name may be similar to the related feature in a previously explained example. Features specific to a given example will be described in that particular example. The reader should understand that a given feature need not be the same or similar to the specific portrayal of a related feature in any given figure or example.

### Definitions

The following definitions apply herein, unless otherwise indicated. “Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder. “Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation. “Coupled” means connected, either permanently or releasably, whether directly or indirectly through intervening components.

The disclosed winch is a lightweight and compact device designed for efficient load management. features a frame made from aerospace-grade aluminum, equipped with lugs for attaching high-strength shackles, and a cylindrical spool holding at least 20 feet of high-strength synthetic rope. The spool is coupled with toothed gears at each end, enabling secure load handling. The winch includes a dual-pawl release mechanism—comprising a handle pawl and a frame pawl—that ensures controlled, safe load release, with a safety feature that prevents simultaneous disengagement under load. The tooth-pawl system is engineered for high load capacity, efficient force distribution, and enhanced durability, allowing the use of lightweight materials without compromising strength. Additionally, the Capio device provides a high-load rope termination solution, featuring a friction bollard, clamping plate, and rope latching plate to ensure a secure grip and controlled release under varying load conditions.

### Winch

The winch comprises a frame made from a lightweight alloy, with a non-limiting example being aerospace-grade aluminum. It includes at least two lugs to attach high-strength shackles that support the load. It further includes a spool and rope comprising a cylindrical spool with a high-strength synthetic rope. In a non-limiting example, the spool is 2 inches in diameter and holds 20 feet of ⅛-inch-diameter high-strength synthetic rope. Coupled to each end of the spool is a toothed gear.

The winch further includes a release mechanism comprising a handle pawl released via a finger trigger or by driving the crank to its limit away from the line guide, and a frame pawl released via a finger trigger on the bottom of the frame. A safety mechanism ensures that pawls can be disengaged only one at a time under load, allowing controlled lowering. Lastly, the winch includes an anchoring system with high-strength shackles and a pulley for efficient load management, which can be secured to anchor points using carabiners, climbers' slings, or strong knots.

### Frame and Pawl Release

The winch employs two pawls: the handle pawl and the frame pawl. These pawls work in tandem to ensure that the line load is always supported by at least one pawl at any given time, providing a secure and reliable mechanism for load management. The pawls are designed to disengage one at a time when the line is under load. This ensures that the load can be released in a controlled, stepwise manner, minimizing the risk of sudden or accidental release. The handle pawl can be disengaged by either a finger trigger or by driving the crank to its limit away from the line guide. The frame pawl is disengaged using a finger trigger located at the bottom of the frame. It also provides free-spooling capability; when the line load is minimal or absent, both pawls can be disengaged simultaneously, allowing the line to be free-spooled off the drum without resistance.

### Tooth Pawl

The tooth-pawl geometry is specifically designed to handle high load capacities relative to the winch's compact size. Its unique design ensures that forces are distributed efficiently across the spool, allowing the winch to support heavy loads without compromising its structural integrity. Its geometry enables the use of lower-density metals, which are typically not strong enough for high-load applications. This thereby reduces the overall weight of the winch while maintaining its strength and durability.

The tooth-pawl interface is engineered to provide crisp, secure engagement, ensuring the spool locks firmly under load. The sharp, well-defined interface minimizes the risk of slippage, enhancing the winch's reliability during operation. Additionally, the tooth-pawl interface is designed with a unique wear profile that improves fitment and engagement strength over time. As the components wear, the contact area increases, enhancing locking performance rather than degrading it.

The spool-pawl tooth interface comprises a spool featuring a custom-engineered tooth profile with specific angles and curvatures that ensure the spool locks securely under load and distributes forces to the most robust sections of the spool. The pawl is shaped to complement the tooth profile, allowing precise, smooth locking and unlocking. The innovative geometry optimizes stress distribution across the tooth-pawl interface. This allows the use of lightweight materials, such as low-density metals, without sacrificing strength.

Lastly, the tooth-pawl system is designed for immediate and secure engagement, which is critical for safety during high-load operations. The pawl can be disengaged smoothly when required, allowing for controlled release of the load.

### Capio

The Capio is a high-load temporary rope termination device designed to securely hold high-strength ropes under significant loads while allowing for quick release and reuse without compromising the rope's integrity. It comprises a friction bollard, the central element of the Capio. The friction bollard resists the rope pull, allowing it to be securely held under load. The bollard is designed to support most of the rope's tension without damaging it.

It further comprises a clamping and rope latching plate. The clamping plate works in conjunction with the friction bollard to compress the rope against the Capio body. The plate has grooves to maximize grip and ensure the rope remains securely held in place. The rope latching plate facilitates the insertion and adjustment of the rope within the device. It includes a spring latch mechanism for easy rope threading and securing. Lastly, it includes a release mechanism that allows the rope to be quickly and safely disengaged from the clamping plate and friction bollard. Under light loads, the rope can be released by unwrapping it from the bollard and threading it out of the device. Under heavier loads, the rope can be hand-fed through the friction bollard for controlled release.

### Method for Using the Winch

The invention is a compact, manual winching system designed for pulling and lifting loads in outdoor and utility applications. The following is a non-limiting example of how to use the winch. Other methods may be employed; for brevity, not all the methods currently conceived or envisioned will be disclosed.

### How to Use the Winching System

Before using the winch, it is essential to inspect all components, including the winch, line, Capio, doubler, handles, pins, and slings, for any damage or wear. Free-spool the line by disengaging the crank and frame pawls, leaving about three wraps on the spool to maximize pulling force and prevent tangles. Securely attach the winch and line ends to a stable anchor and load points using the provided shackles and slings, ensuring straight-line pulls for optimal performance.

The winch can be operated on a single-line or a double-line mode. For a single line pull that supports up to 1,000 lbs. with a ~20 ft pull distance, attach the winch to either the anchor or the load, and the Capio to the opposite point. Feed the line through the Capio, minimize slack, and terminate the line by wrapping it around the friction bollard and plate, securing it with the wing nut. For a double-line pull, which increases capacity to 2,000 lbs. with a ~10 ft pull distance, use the doubler for mechanical advantage. Attach the winch to the anchor, the Capio to the winch body, and the doubler to the anchor point. Feed the line through the Capio and doubler, then terminate it as described for the single-line setup. Operate the winch with smooth, steady crank strokes, keeping the line evenly wrapped on the spool.

To release the load, support it first, and choose between two methods: incremental handle release for heavier loads or Capio release for lighter loads under ~350 lbs. The incremental method involves controlled movements of the crank and pawls to gradually release the load, while the Capio release uses the friction plate for faster payout. After releasing the load, re-spool the line neatly, inspect the system for wear or damage, and store it clean and dry. Regular maintenance, including cleaning and inspection, ensures the winch remains in optimal condition for future use.

With reference to the figures, the LIGHTWEIGHT COMPACT WINCH will now be described. The elements discussed herein function to operate the winch system. The reader will appreciate, from the figures and the description below, that the presently disclosed elements address many of the shortcomings of conventional winches. For example, the winch features a lightweight frame made from aerospace-grade aluminum, a crank mechanism, and a spool with toothed gears for secure load handling. It incorporates a dual-pawl release system for controlled load release and a safety mechanism to prevent simultaneous disengagement under load. The Capio serves as a temporary rope termination device, equipped with components such as a friction plate, wingnut, gate latch, and release pin, ensuring secure grip and controlled release of high-strength ropes under significant loads.

### The Upper Handle and Winch

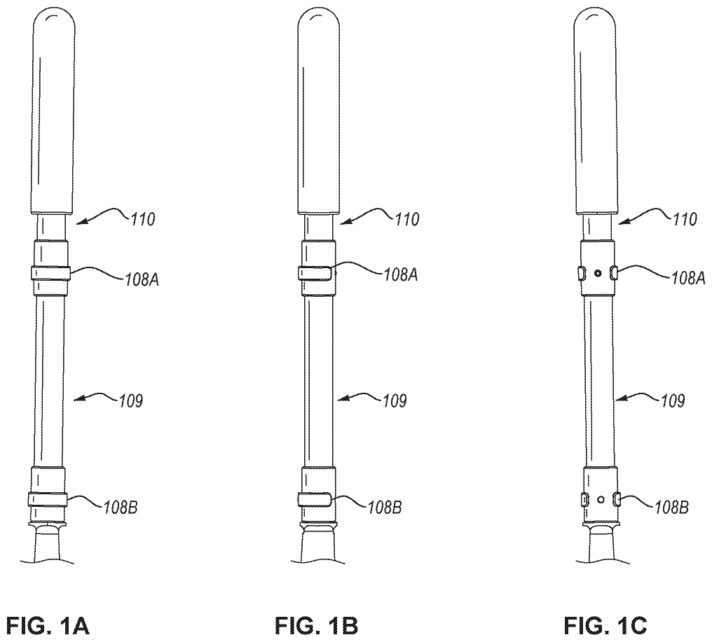

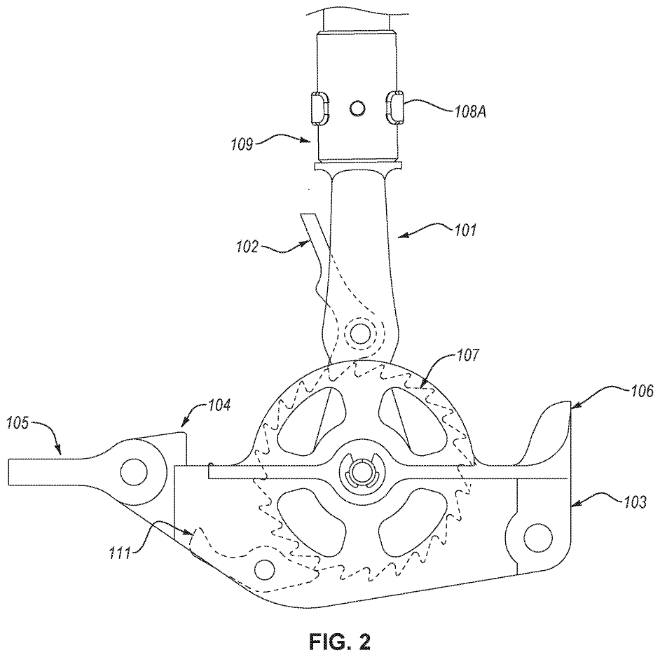

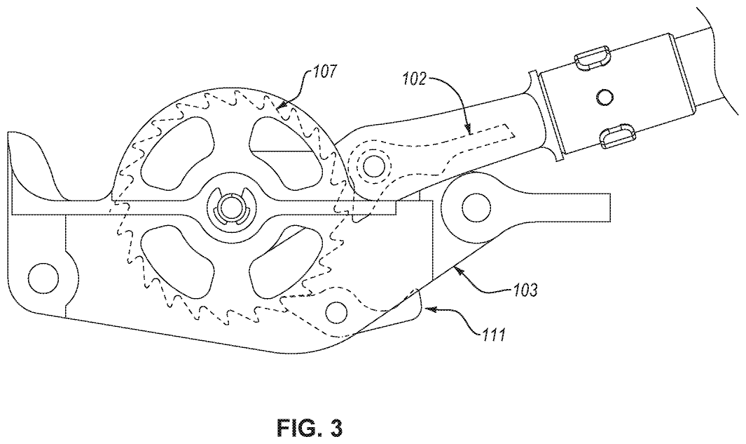

The winch is coupled to a handle, 100 (FIGS. 1A-1C). The handle comprises an upper handle 110, a lower handle 109, and retention clips 108A and 108B. The handle is coupled to the winch via the lower handle, 109 (FIG. 2). The winch comprises the crank 101, the crank pawl, 102, and the spool 107. The spool 107 further comprises toothed gears that are coupled to each end of the spool. The winch further comprises a frame, 103. Disposed on the frame is a fairlead, 106, and a shackle, 105. The crank 101 is coupled to the crank pawl 102, which couples with the tooth gear portion of the spool 107, and the frame pawl 111 is coupled to the frame 103 and couples to the tooth gear portion of the spool 107, acting as a releasable lock (see FIG. 3).

### Capio

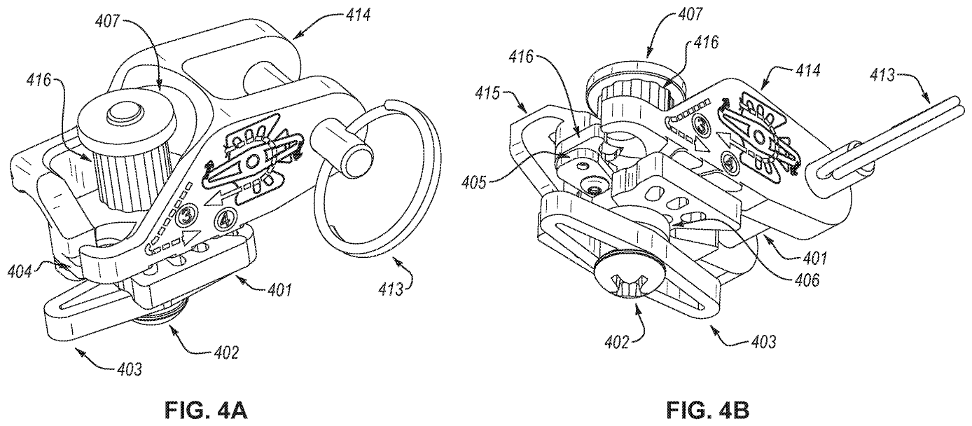

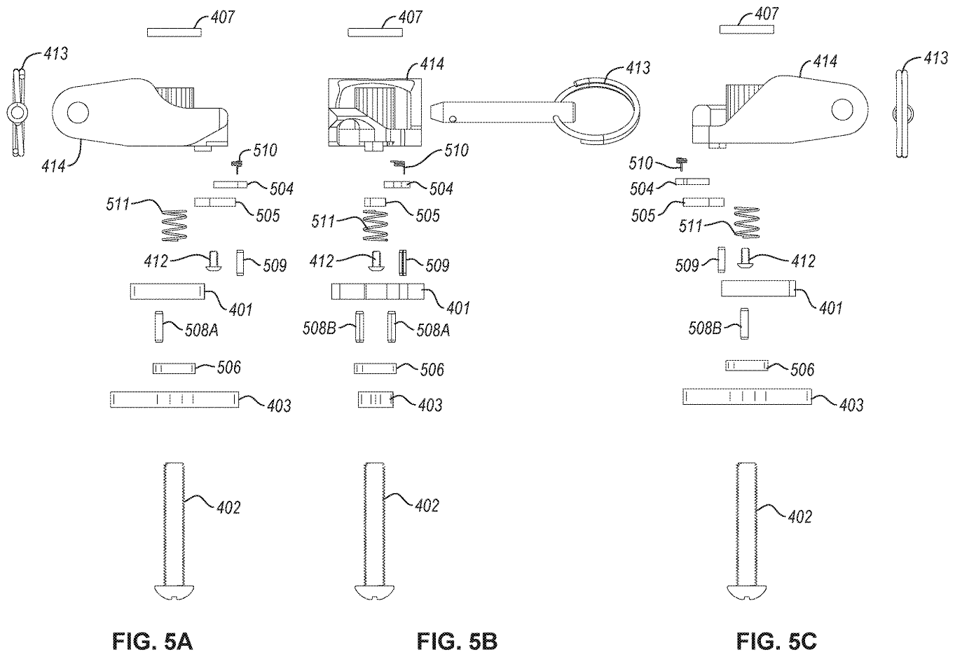

With reference to FIGS. 4A, 4B, 5A, 5B, and 5C the elements of the Capio will be described. The Capio is a temporary rope termination device designed to securely hold high-strength ropes under significant loads while allowing for quick release and reuse. The Capio comprises (FIGS. 4A and 4B) a frame 414, a release pin 413, a friction plate 401, a main screw 402, a wingnut 403, a fairlead 415, a gate latch 404, a latch stay 405, a frame bollard 416, and a flange nut 407. FIGS. 5A-5C depict the inner components of the Capio. The inner pieces comprise a latch spring 510, a gate latch 504, a latch stay 505, a latch pin 509, two plate pins 508A and B, a spacer 506, a stay screw 412, and a plate spring 511.

The disclosure above encompasses multiple distinct inventions with independent utility. While each of these inventions has been disclosed in a particular form, the specific embodiments disclosed and illustrated above are not to be considered in a limiting sense, as numerous variations are possible. The subject matter of the inventions includes all novel and non-obvious combinations and subcombinations of the various elements, features, functions, and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements, and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

1. A device for pulling loads, comprising: a handle, a winch, a rope, and a Capio where the handle is coupled to the winch, the rope is coupled to the winch and to the Capio.

2. The device of claim 1, wherein the handle further comprises an upper handle that is coupled to a lower handle, and at least one retention clip is disposed on the upper handle or lower handle, and the lower handle is coupled to the winch.

3. The device of claim 1, wherein the winch comprises:
a) a crank coupled to the lower handle; a crank pawl coupled to the crank;
b) a frame further comprising:
(i) a fairlead disposed on the frame,
(ii) a shackle disposed on the frame distal to the fair lead,
(iii) a spool further comprising toothed gears that are coupled to each end of the spool,
(iv) a frame pawl coupled to the frame, and
(v) where the crank pawl or frame pawl couples to the tooth gear portion of the spool;
c) and the rope wraps around the spool.

4. Where the Capio of claim 1 further comprises: a frame, a release pin, a friction plate, a main screw, a wingnut, a fairlead, a gate latch, a latch stay, a frame bollard, and a flange nut;
where:
a) the release pin is coupled to the frame; the flange nut, frame bollard, friction plate, and wingnut are coupled to the frame via the main screw; and
b) disposed on the frame is a fairlead, a gate latch, and a latch stay.

5. A temporary rope termination device comprising: a frame, a release pin, a friction plate, a main screw, a wingnut, a fairlead, a gate latch, a latch stay, a frame bollard, and a flange nut; where:
a) the release pin is coupled to the frame; the flange nut, frame bollard, friction plate, and wingnut are coupled to the frame via the main screw; and
b) disposed on the frame is a fairlead, a gate latch, and a latch stay; and
further comprising:
c) a latch spring coupled to a latch pin that is coupled to the latch stay, two plate pins coupled to the friction plate, a spacer disposed between the friction plate and the wingnut, a stay screw coupled to the latch stay, and a plate spring disposed between the latch stay and the friction plate.
